(19) United States
(12) Patent Application Publication
(10) Pub. No.: US 2005/0155826 A1
(43) Pub. Date: Jul. 21, 2005

(54) Friction engaging device

(76) Inventors: Tetsuya Kohno, Okazaki-shi (JP); Yuji Yasuda, Nishikamo-gun (JP)

Correspondence Address: KENYON & KENYON, 1 BROADWAY, NEW YORK, NY, 10004, US

(21) Appl. No.: 11/032,059

(22) Filed: Jan. 11, 2005

(30) Foreign Application Priority Data
Jan. 15, 2004 (JP) 2004-008525

(51) Int. Cl. F16D 51/00

(52) U.S. Cl. 188/79.61

(57) ABSTRACT

A diaphragm spring is formed so as to be elastically deformable between a first shape for maintaining an engaged state for engaging a brake disc with a pressed plate without requiring the continuous operation of a hydraulic cylinder, and a second shape for maintaining a disengaged state for disengaging the brake disc from the pressed plate without requiring the operation of the hydraulic cylinder. Therefore, after the shape of the diaphragm spring is made one of the first shape and the second shape due to temporary operation of the hydraulic cylinder, power for continuously operating the hydraulic cylinder for maintaining the engaged state or the disengaged state is not required. As a result, an energy loss is not caused, and the fuel efficiency is increased.

### INCORPORATION BY REFERENCE

The disclosure of Japanese Patent Application No. 2004-008525 filed on Jan. 15, 2004, including the specification, drawings and abstract is incorporated herein by reference in its entirety.

### BACKGROUND OF THE INVENTION

1. Field of the Invention

The invention relates to a friction engaging device in which paired members are engaged with/disengaged from each other due to operation of an actuator for elastically deforming a spring. More particularly, the invention relates to a technology for reducing an energy loss due to continuous operation of the actuator.

2. Description of the Related Art

There is a known vehicle including a dry type single plate friction clutch as a friction engaging device which is provided between an engine and a transmission and which transmits/interrupts power from the engine, or a clutch and a brake as a plurality of hydraulic friction engaging devices whose engagement/disengagement is controlled in order to achieve a shift speed of a stepped automatic transmission. For example, Japanese Patent Laid-Open Publication No. 08-189534 discloses a dry type single plate friction clutch. This dry type single plate friction clutch is engaged, when a clutch disc and a flywheel are pressed to a pressure plate by a diaphragm spring and therefore a pressure load is generated. The dry type single plate friction clutch is disengaged, when the diaphragm spring is elastically deformed due to operation of a hydraulic cylinder and therefore the pressure load applied to the pressure plate by the diaphragm spring is reduced.

However, in order to keep the clutch disc disengaged from the flywheel using the elastic deformation of the diaphragm spring, that is, in order to elastically deform the diaphragm spring and maintain the elastically deformed state, the hydraulic cylinder needs to be operated continuously. Also, when the clutch disc is kept engaged with the flywheel by the elastic deformation of the diaphragm spring, the hydraulic cylinder needs to be operated continuously. Even in the case where the pressure plate is made to generate the pressure load directly due to the operation of the hydraulic cylinder without using the diaphragm spring, or in the case where a hydraulic friction engaging device of a stepped automatic transmission is disengaged by a return spring and the hydraulic friction engaging device is engaged by being supplied with a pressure load by the operation of a piston due to a hydraulic pressure, the hydraulic cylinder or the hydraulic piston needs to be operated continuously.

Namely, although one of the engaged state and the disengaged state of the friction engaging device is maintained by the diaphragm spring, the return spring or the like, the other state needs to be maintained by an actuator such as the hydraulic cylinder. Therefore, power for generating a hydraulic pressure for operating the hydraulic cylinder or the like is required. For example, power is required for generating a hydraulic pressure for maintaining the disengaged state of the dry type single plate friction clutch or for achieving a shift speed of the stepped automatic transmission even when shifting of the stepped automatic transmission is not performed. Accordingly, an energy loss in the steady state cannot be avoided, and the fuel efficiency of a vehicle may be reduced.

### SUMMARY OF THE INVENTION

According to an aspect of the invention, a friction engaging device is provided. This friction engaging device includes a friction member which is attached to one member of paired members that are coaxially provided so as to be rotatable with respect to each other; a pressing member which presses the friction member to the other member of the paired members; and a spring which makes the pressing member generate a pressure load for pressing the friction member to the other member of the paired members. The spring is formed so as to be elastically deformable between a first shape for maintaining a state in which the pressing member is made to generate the pressure load and a second shape for maintaining a state in which the pressing member is not made to generate the pressure load. The spring is elastically deformed from the second shape to the first shape due to operation of an actuator in order to engage the paired members with each other. The spring is elastically deformed from the first shape to the second shape due to the operation of the actuator in order to disengage the paired members from each other.

With the friction engaging device, the spring is formed so as to be elastically deformable between the first shape and the second shape. The first shape is used for maintaining the state in which the pressing member is made to generate the pressure load without requiring the operation of the actuator in order to engage the paired members with each other. The second shape is used for maintaining the state in which the pressing member is not made to generate the pressure load without requiring the operation of the actuator in order to disengage the paired members from each other. Accordingly, after the spring is elastically deformed from the second shape to the first shape or from the first shape to the second shape due to the operation of the actuator, in both the case where the engaged state is maintained and the case where the disengaged state is maintained, power for continuously operating the actuator is not required. As a result, when the engaged state or the disengaged state is maintained, there is no energy loss in the steady state in which the friction engagement device is not being disengaged. Namely, the entire energy loss including an energy loss during the operation of the actuator is reduced, and therefore the fuel efficiency is increased.

### BRIEF DESCRIPTION OF THE DRAWINGS

The above-mentioned embodiment and other embodiments, objects, features, advantages, technical and industrial significance of this invention will be better understood by reading the following detailed description of the exemplary embodiments of the invention, when considered in connection with the accompanying drawings, in which:

FIG. 1 is a cross sectional view showing a structure of a brake that is a friction engaging device constituting a stepped automatic transmission for a vehicle, to which the invention is applied, the brake being formed substantially symmetrical with respect to the axis, and FIG. 1 shows only the upper half portion of the brake with respect to the axis;

FIG. 2A is a view showing a diaphragm spring viewed from the left-hand side in the axial direction in FIG. 1;

FIG. 2B is a cross sectional view taken along a line A-A in FIG. 2A;

FIG. 3 is a view showing a state where the diaphragm spring is elastically deformed from the shape thereof shown in FIG. 1 due to operation of a hydraulic cylinder and is further reversed;

FIGS. 4A and 4B are a view showing a turnover characteristic of the diaphragm spring using a stroke corresponding to displacement of an actuator and a pressure load;

FIGS. 5A and 5B are a view showing the turnover characteristic of the diaphragm spring obtained in consideration of hysteresis, along with a characteristic of a diaphragm spring in related art;

FIG. 6 is a cross sectional view showing a structure of a twin clutch that is a friction engaging device to which the invention is applied, the twin clutch being formed substantially symmetrical with respect to the axis, and FIG. 6 shows only the upper half portion of the twin clutch with respect to the axis and shows another embodiment of FIG. 1;

FIG. 7 is a view showing another embodiment of FIG. 6, in which an electric motor is provided, instead of the hydraulic cylinder provided in the embodiment shown in FIG. 6, as the actuator for elastically deforming a first diaphragm spring and a second diaphragm spring; and

FIG. 8 is a view showing another embodiment of FIG. 7, and positions and structures of a first clutch and a second clutch in FIG. 8 are different from those in the embodiment shown in FIG. 7.

### DETAILED DESCRIPTION OF THE PREFERRED EMBODIMENTS

In the following description, the present invention will be described in more detail in terms of exemplary embodiments.

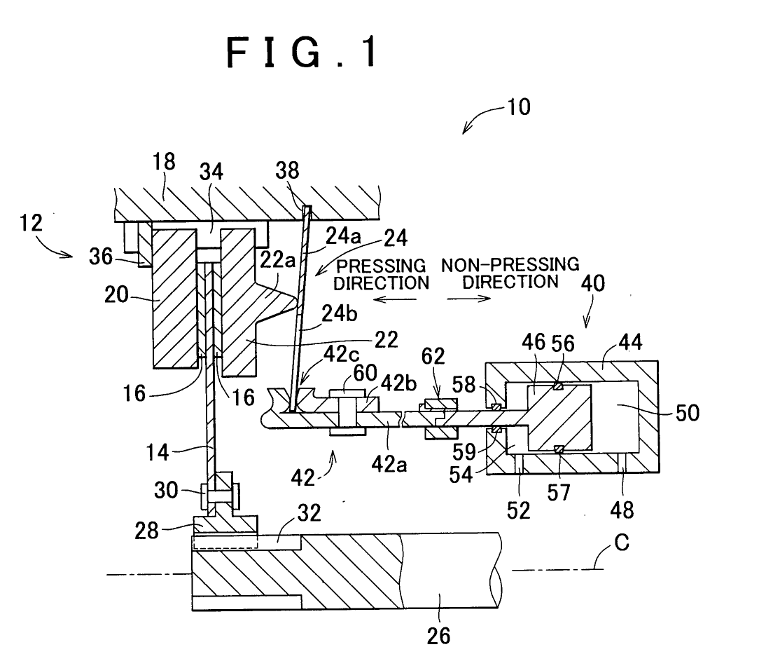

FIG. 1 is a cross sectional view showing a structure of a brake 12 that is a friction engaging device constituting a stepped automatic transmission 10 for a vehicle, to which the invention is applied. Since the brake 12 is formed so as to be symmetric with respect to an axis C, only an upper half portion of the brake 12 with respect to the axis C is shown in FIG. 1. The stepped automatic transmission 10 mainly includes a plurality of planetary gear sets. A shift speed from among plural shift speeds is selectively achieved due to combination of engagement operations of a clutch and a brake which are friction engaging devices including the brake 12 such that the vehicle can run appropriately based on a vehicle state such as a vehicle speed and an accelerator pedal operation amount. Thus, an output from an engine serving as a driving power source for running, which is input via a torque converter or the like, is transmitted to a drive shaft via a differential gear unit, an axle, and the like (not shown).

The brake 12 includes a ring-shaped friction member 16; a ring-shaped pressing plate 22; and a diaphragm spring 24. The ring-shaped friction member 16 is attached to an outer peripheral portion of a ring-shaped brake disc 14 which is one member of paired members that are coaxially provided so as to be rotatable with respect to each other. The ring-shaped pressing plate 22 is a pressing member which presses the ring-shaped friction member 16 to a ring-shaped pressed plate 20 that is the other member of the paired members and that is attached to a housing 18 so as not to be rotatable with respect to the housing 18 and so as to be movable in the direction of axis C. The diaphragm spring 24 is a spring for making the pressing plate 22 generate a pressure load P for engaging pressing the friction member 16 with the pressed plate 20, that is, for pressing the friction member 16 to the pressed plate 20. The brake 12 selectively couples a rotational element or the like, which is formed alone by one of a sun gear, a carrier and a ring gear constituting the planetary gear set or which is formed by coupling part of a sun gear, a carrier, and a ring gear constituting each of plural planetary gear sets to each other, to the non-rotatable housing 18 via an intermediate shaft 26 coupled to the brake disc 14, and stops the rotation.

For example, the brake disc 14 is integrally fixed to a disc hub 28 with a rivet 30 at an inner periphery portion thereof. The brake disc 14 is provided so as not to be rotatable with respect to the intermediate shaft 26 and so as to be movable in the direction of the axis C, when the brake disc hub 28 is splined to an intermediate shaft fitting portion 32 having a spline tooth, which is formed at a shaft end of the intermediate shaft 26. The friction member 16 is provided integrally on each of both outer peripheral surfaces of the brake disc 14 at a position at which the brake disc 14 contacts the pressed plate 20 and the pressing plate 22, that is, at substantially the same position as the pressed plate 20 and the pressing plate 22 in the radial direction.

The pressed plate 20 and the pressing plate 22 are provided so as not to be rotatable with respect to the housing 18 and so as to be movable in the direction of the axis C, when the pressed plate 20 and the pressing plate 22 are splined to a housing fitting portion 34 having a spline tooth, which is formed on an inner peripheral surface of the housing 18. A ring-shaped snap ring 36, which serves as a stopper, is fitted in a ring-shaped mounting groove formed in the housing fitting portion 34. With such a structure, the pressed plate 20 is positioned so as to be immovable in the leftward direction in FIG. 1, that is, the direction in which the brake disc 14 is pressed to the pressed plate 20 (hereinafter, referred to as the “pressing direction”). In addition, a pressing plate protruding portion 22a for receiving the pressure load P from the diaphragm spring 24 is provided in the pressing plate 22.

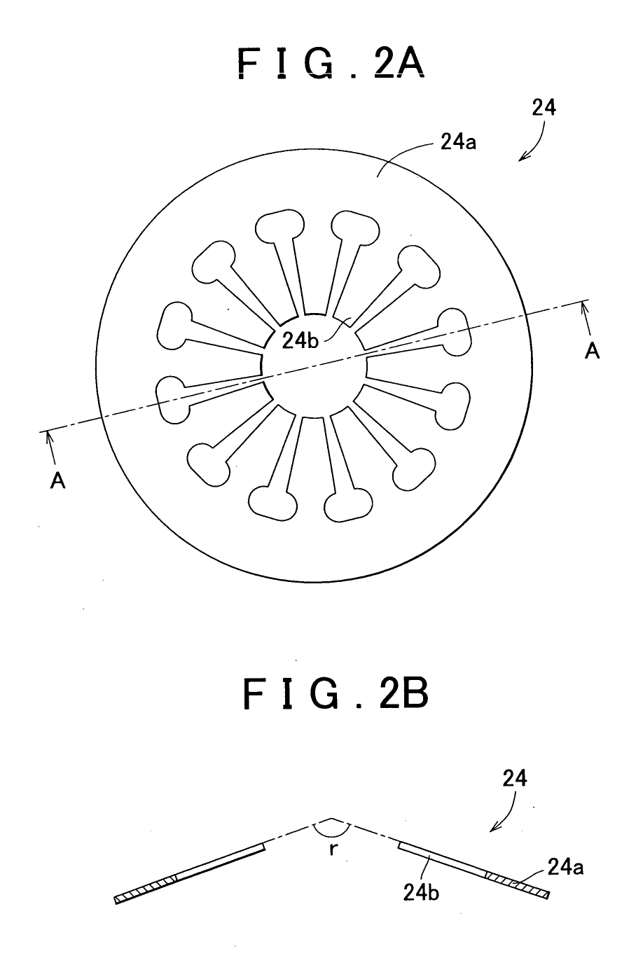

The diaphragm spring 24 is a spring member having a cone-shaped portion in which an inner periphery is deviated with respect to an outer periphery in an axial direction, that is, a spring member having a partial cone shape with a predetermined apex angle r as a whole. The diaphragm spring 24 is fitted to a support groove 38 formed in the housing 18. FIG. 2A is a view showing the diaphragm spring 24 viewed from the left side of the direction of the axis C in FIG. 1. FIG. 2B is a cross sectional view taken along line A-A in FIG. 2A. As shown in FIG. 2B, the diaphragm spring 24 has a ring-shaped portion 24a, which has a partial cone shape with the predetermined apex angle r at all times due to a spring force, on the outer peripheral side; and a plurality of protruding portions 24b which protrudes toward the center from the ring-shaped portion 24a. The pressure load P is applied to the pressing plate 22 using the force for attempting to maintain the partial cone shape of the diaphragm spring 24. In the state of the brake 12 shown in FIG. 1, the pressure load P is applied to the pressing plate 22 by the diaphragm spring 24 using the support groove 38 as a supporting point. At this time, the brake disc 14 is brought to the engaged state in which the brake disc 14 is pressed to the pressed plate 20 and the pressing plate 22. Namely, the rotation of the brake disc 14 is stopped. The spring force, the shape, the position and the like of the diaphragm spring 24 are appropriately set such that the brake 12 is brought to the engaged state using the force for attempting to maintain the partial cone shape of the diaphragm spring 24. The shape of the diaphragm spring 24 for maintaining the engaged state is referred to as a first shape.

Next, a description will be made concerning the case where the state of the brake disc 14 is changed from the engaged state shown in FIG. 1 to the disengaged state in which the brake disc 14 is not pressed to the pressed plate 20 and the pressing plate 22, that is, the state in which the brake disc 14 is rotatable.

As shown in FIG. 1, the stepped automatic transmission 10 includes an actuator for elastically deforming the diaphragm spring 24, for example, a hydraulic cylinder 40. The diaphragm spring 24 is elastically deformed via a diaphragm spring operation member 42, and the pressure load P applied by the diaphragm spring 24 in the pressing direction is cancelled, whereby the brake 12 is disengaged. For example, the hydraulic cylinder 40 mainly includes a ring-shaped cylinder housing 44 and a piston 46. The hydraulic cylinder 40 has a first oil chamber 50 which receives a hydraulic pressure from a first oil passage 48 formed in the cylinder housing 44; and a second oil chamber 54 which receives a hydraulic pressure from a second oil passage 52 formed in the cylinder housing 44. O-rings 56 and 57, and O-rings 58 and 59 are provided for oil seal. The diaphragm spring operation member 42 is formed of a ring-shaped first member 42a and a ring-shaped second member 42b which are integrally fixed to each other by a rivet 60, and an engagement portion 42c which is formed by the first member 42a and the second member 42b. The inner peripheral end of the protruding portion 24b of the diaphragm spring 24 is held by the engagement portion 42c.

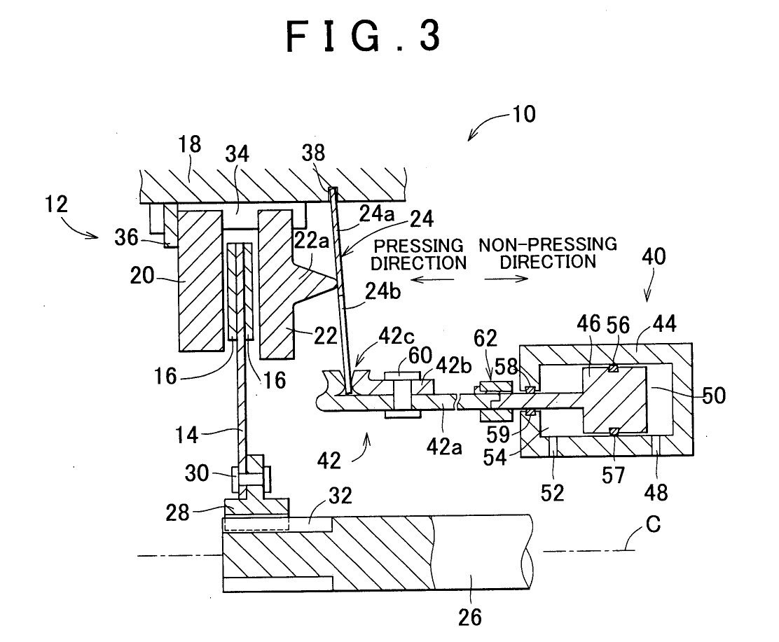

Then, the diaphragm spring operation member 42 is coupled to the piston 46 at a coupling portion 62 so as to be immovable with respect to the piston 46 in the direction of the axis C. When the hydraulic pressure in the second oil chamber 54 is made higher than the hydraulic pressure in the first oil chamber 50, the piston 46 moves in the direction opposite to the pressing direction (hereinafter, referred to as the “non-pressing direction”). Thus, the protruding portion 24b, which is held by the engagement portion 42c, is pulled in the non-pressing direction, and then the diaphragm spring 24 is elastically deformed. As a result, as shown in FIG. 3, the pressure load P is cancelled, and the brake 12 is disengaged.

The pressure load P generated by the diaphragm spring 24 at this time is applied in the non-pressing direction due to a turnover characteristic (hereinafter, referred to as a “T/O characteristic”) of the diaphragm spring 24. In this state, the disengaged state of the brake 12 is maintained, even when pulling of the protruding portion 24b of the diaphragm spring 24 due to the operation of the hydraulic cylinder 40 is not performed. The shape of the diaphragm spring 24 for maintaining the disengaged state is referred to as a second shape.

The T/O characteristic of the diaphragm spring 24 will be described below. The T/O characteristic of the diaphragm spring 24 corresponds to the characteristic of the ring-shaped portion 24a of the diaphragm spring 24 which is a spring member. When a force is applied for increasing the predetermined apex angle r of the ring-shaped portion 24a having a partial cone shape, that is, when a force for flattening the partial cone shape is applied, the internal diameter of the ring-shaped portion 24a is decreased. However, a force for attempting to return the internal diameter to the original internal diameter from the decreased diameter, that is, a force for attempting to maintain the partial cone shape having the predetermined apex angle r at all times is applied to the ring-shaped portion 24a. Then, when the ring-shaped portion 24a exceeds the flat state, a force, which is used for forming the partial cone shape having the predetermined apex angle r on the symmetrically opposed side, is applied to the ring-shaped portion 24a, whereby the partial cone shape is maintained. This is the T/O characteristic of the diaphragm spring 24. When the diaphragm spring 24 is brought from one state, where the ring-shaped portion 24a has the partial cone shape with the predetermined apex angel r, to the other state where, the ring-shaped portion 24a is reversed so as to have the partial cone shape with the predetermined apex angle r on symmetrically opposed side, with respect to the flat state where the ring-shaped portion 24a is flat, a force from the outside is required until the force is applied such that the reversed state is realized. Other than this, however, the force from the outside is not required.

As mentioned above, the diaphragm spring 24 is formed so as to be elastically deformable between the first shape and the second shape. As shown in FIG. 1, the first shape is used for maintaining the state in which the pressing plate 22 is made to generate the pressure load P such that the engaged state of the brake 12 is maintained without operating the hydraulic pressure cylinder 40. As shown in FIG. 3, the second shape is used for maintaining the state in which the pressing plate 22 is made not to generate the pressure load P such that the disengaged state of the brake 12 is maintained without operating the hydraulic cylinder 40. When the brake 12 is returned to the disengaged state to the engaged state, the hydraulic pressure in the first oil chamber 50 is made higher than the hydraulic pressure in the second oil chamber 54 in the hydraulic cylinder 40 and therefore the piston 46 moves in the pressing direction, and the protruding portion 24b held by the engagement portion 42c is pressed in the pressing direction, whereby the diaphragm spring 24 is elastically deformed from the second shape to the first shape. Accordingly, the hydraulic cylinder needs to be operated only when the diaphragm spring 24 is elastically deformed from the first shape to the second shape, or from the second shape to the first shape. Namely, the hydraulic cylinder 40 needs to be operated only when shifting of the stepped automatic transmission 10 is performed. In the steady state in which shifting is not performed, the operation of the hydraulic cylinder 40 is not required. Accordingly, an energy loss due to the continuous operation of the hydraulic cylinder 40 is not caused, and therefore the fuel efficiency is increased. The above-mentioned hydraulic pressure uses, as an original pressure, the hydraulic pressure which is generated by an electric oil pump driven by electric power from, for example, a mechanical oil pump driven by the engine, a battery or the like that is provided in the stepped automatic transmission 10. Accordingly, if the hydraulic cylinder 40 is continuously operated, an energy loss is increased, and therefore the fuel efficiency may be reduced.

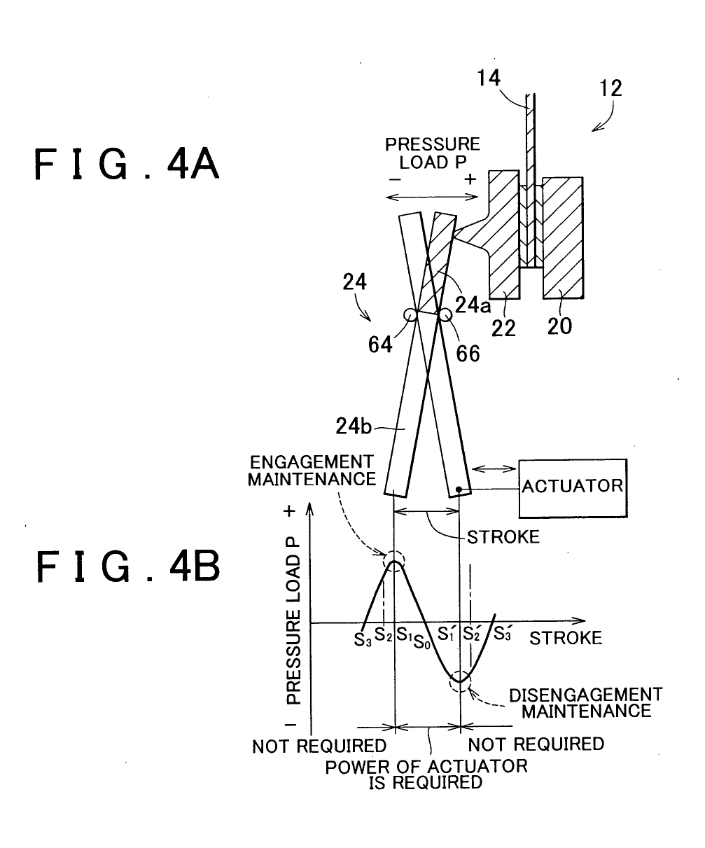

FIG. 4 is a view showing the T/O characteristic of the diaphragm spring 24 using a stroke corresponding to displacement of the actuator and the pressure load P. In FIG. 4, the structures of the diaphragm spring 24 and the brake 12 are substantially the same as those in FIG. 1. However, the supporting point of the diaphragm spring 24 is not at the outer peripheral end. Supporting members 64 and 66 serving as the supporting point are provided between the outer periphery and the inner periphery, for example, between the ring-shaped portion 24a and the protruding portion 24b. Concerning the pressure load P, the right-hand side in FIG. 4, that is, the side on which the pressing plate 22 is made to generate the pressure load P is used as the positive side. As shown in FIG. 4, the pressure load P is on the positive side during the stroke from S₀ to S₃, and the engaged state of the brake 12 is maintained ‘(engagement maintenance). On the other hand, during the stroke from S₀ to S₃′, the pressure load is on the negative side, and the disengaged state of the brake 12 is maintained (disengagement maintenance). For example, when the diaphragm spring 24 is provided such that the stroke is between S₁ and S₃, in the engagement maintenance at the stroke S₁ or in the disengagement maintenance at the stroke S₁′, the force (power) generated due to the operation of the actuator is not required. On the other hand, when the state is changed from the engagement maintenance to the disengagement maintenance, the force of the actuator is required during the stroke from S₁ to S₀. Similarly, when the state is changed from the disengagement maintenance to the engagement maintenance, the force of the actuator is required during the stroke from S₁′ to S₀. Also, the diaphragm spring 24 is preferably provided such that the stroke is between S₂ and S₂′.

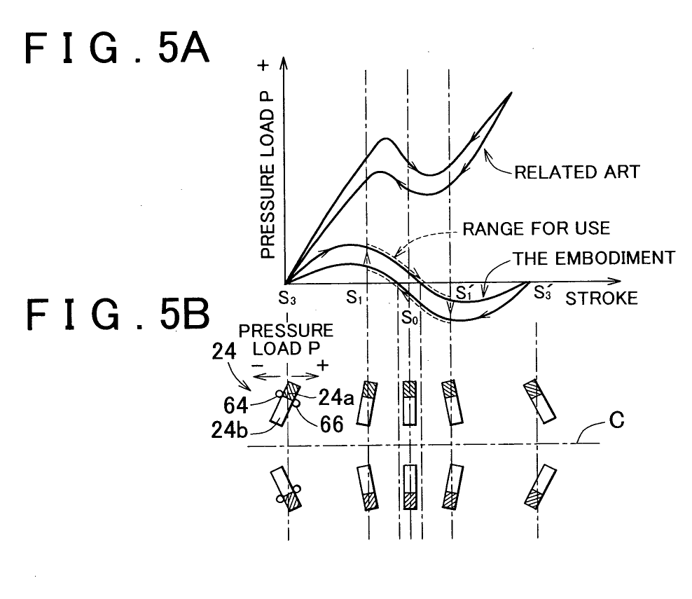

FIGS. 5A and 5B are views showing the T/O characteristic of the diaphragm spring 24 obtained in consideration of hysteresis, along with the characteristic of the diaphragm spring in the related art. In FIGS. 5A and 5B, the structures of the diaphragm spring 24 and the supporting members 64 and 66 are substantially the same as those in FIG. 4. Namely, as in the case of FIG. 4, the stroke corresponds to the displacement of the actuator, and concerning the pressure load P, the right-hand side in FIG. 5B is used as the positive side. Also, FIG. 5B shows the process of the elastic deformation of the diaphragm spring 24 corresponding to the stroke. As shown in FIG. 5A, in the diaphragm spring 24, there are both the positive side and the negative side for the pressure load P according to the stroke. On the other hand, in the diaphragm spring in the related art, the pressure load P is the positive side in the entire stroke. In the related art, the method is employed in which the pressure load P is applied in only one direction, and the pressure load P is cancelled by operating the actuator. This method is inconvenient when the diaphragm spring is reversed as in the embodiment. Therefore, the characteristic of the diaphragm spring the related art is shown in FIG. 5A as an example compared to the embodiment. Also, in the embodiment, the positive and the negative of the pressure load P is reversed only when the stroke amount exceeds the stroke S₀ by a predetermined amount due to the hysteresis characteristic. Namely, in order to elastically deform from the first shape to the second shape, or from the second shape to the first shape, the pressure load P is required until the shape of the diaphragm spring exceeds substantially flat state from one state to the other state side by a predetermined amount by operating the actuator. The point at which the shape of the diaphragm spring exceeds the substantially flat state by the predetermined amount is referred to as the operation point of the diaphragm spring 24. The dashed line in FIG. 5A shows the preferably set range in which the diaphragm spring 24 is used. The predetermined amount from the stroke S₀ is set depending on the characteristic and the usage of the diaphragm spring 24.

As mentioned above, according to the embodiment, the diaphragm spring 24 is formed so as to be elastically deformable between the first shape and the second shape. In this case, after the diaphragm spring 24 is deformed from the second shape to the first shape or from the first shape to the second shape due to the operation of the hydraulic cylinder 40, the power for continuously operating the hydraulic cylinder 40 for maintaining the engaged state or the disengaged state is not required. Accordingly, when the engaged state or the disengaged state is maintained, a power loss (energy loss).in the steady state is not caused. Namely, an entire energy loss including an energy loss during the operation of the hydraulic cylinder 40 is reduced. As a result, the fuel efficiency of the vehicle is increased.

Also, according to the embodiment, the diaphragm spring 24, which has the cone-shaped portion in which the inner periphery deviates with respect to the outer periphery, is used as the spring. Thus, the first shape and the second shape can be easily realized using the turnover characteristic of the diaphragm spring 24. Also, this structure can be realized without an increase in cost as compared to the friction engaging device in the related art.

Also, according to the embodiment, the friction engaging device is the brake 12 whose engagement operation is controlled in order to achieve a shift speed of the stepped automatic transmission 10. Thus, a shift speed of the stepped automatic transmission 10 need not be achieved when shifting of the stepped automatic transmission 10 is not performed. Accordingly, an energy loss due to the operation of the brake is not caused.

Next, a second embodiment of the invention will be described. Note that the same reference numerals will be assigned to the same elements as those in the above-mentioned embodiment, and the description thereof will not be made here.

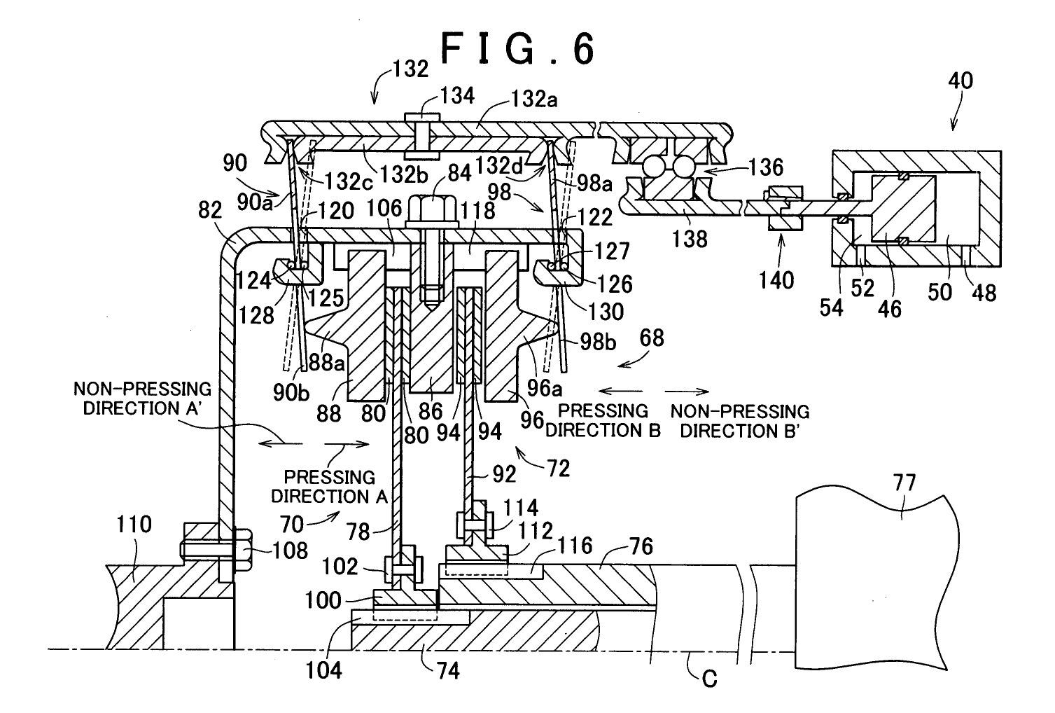

FIG. 6 is a cross sectional view showing a structure of a twin clutch 68 which is a friction engaging device for a vehicle, to which the invention is applied. The twin clutch is formed so as to be substantially symmetrical with respect to the axis C, and only an upper half portion of the twin clutch 68 is shown in FIG. 6. The twin clutch 68 includes, for example, a first clutch 70 and a second clutch 72. The twin clutch 68 is provided between the engine and a stepped automatic transmission 77 including a first input shaft 74 and a second input shaft 76 on the same axis. The twin clutch 68 transmits/interrupts the power, which is transmitted from the engine to the stepped automatic transmission 77 via the first input shaft 74, using the first clutch 70, and the power, which is transmitted from the engine to the stepped automatic transmission 77 via the second input shaft 76, using the second clutch 72. The stepped automatic transmission 77 is a transmission of a constant-mesh parallel two axes type, which is well known as a manual transmission. However, the stepped automatic transmission 77 is an automatic transmission in which the shift speed can be changed among plural shift speeds by a select cylinder and a shift cylinder. By forming the next shift speed in advance and disengaging one of the clutches of the twin clutch 68 while engaging the other clutch of the twin clutch 68, shifting is performed while the transmission state of the driving force is maintained in order to reduce a sense of deceleration or a shock caused when shifting is automatically performed. In the embodiment, a gear for odd-numbered shift speeds is provided on the first input shaft 74. Also, a gear for even-numbered shift speeds is provided on the second input shaft 76. When the shift speed is changed to an odd-numbered shift speed, the first clutch 70 is engaged, that is, brought to the engaged state. When the shift speed is changed to an even-numbered shift speed, the second clutch 72 is engaged, that is, brought to the engaged state.

The first clutch 70 includes a ring-shaped friction member 80; a ring-shaped first pressing plate 88; and a first diaphragm spring 90. The ring-shaped friction member 80 is attached to an outer peripheral portion of a ring-shaped first clutch disc 78 which is one member of paired members that are coaxially provided so as to be rotatable with respect to each other. The ring-shaped first pressing plate 88 is a pressing member for pressing the friction member 80 to a pressed plate 86, which is the other member of the paired members and which is integrally fixed to a support portion integrated flywheel 82 with a bolt 84. The first diaphragm spring 90 is used for making the first pressing plate 88 generate the pressure load P for engaging the first clutch disc 78 to the pressed plate 86, that is, for pressing the first clutch disc 78 to the pressed plate 86. The first clutch 70 transmits power from the engine to the stepped automatic transmission 77 via the first input shaft 74 coupled to the first clutch disc 78.

Similarly, the second clutch 72 includes a ring-shaped friction member 94; a ring-shaped second pressing plate 96; and a second diaphragm spring 98. The ring-shaped friction member 94 is attached to a ring-shaped second clutch disc 92 which is one member of paired members that are coaxially provided so as to be rotatable with respect to each other. The ring-shaped second pressing plate 96 is a pressing member for pressing the friction member 94 to the pressed plate 86 which is the other member of the paired members. The second diaphragm spring 98 is used for making the second pressing plate 96 generate the pressure load P for pressing the second clutch disc 92 to the pressed plate 86. The second clutch 72 includes the second diaphragm spring 98, and transmits power from the engine to the stepped automatic transmission 77 via the second input shaft 76 coupled to the second clutch disc 92.

In the embodiment, the first clutch disc 78 is integrally fixed to a first clutch disc hub 100 with a rivet 102 at the inner periphery portion thereof. The first clutch disc 78 is provided so as not to be rotatable with respect to the first input shaft 74 and so as to be movable in the direction of the axis C, when the first clutch hub 110 is splined to a first input shaft fitting portion 104 having a spline tooth, which is formed at a shaft end of the first input shaft 74. The friction member 80 is provided integrally on each of both outer peripheral surfaces of the brake disc 14 at a position at which the brake disc 78 contacts the pressed plate 86 and the first pressing plate 88, that is, at substantially the same position as the pressed plate 86 and the pressing plate 88 in the radial direction. The first pressing plate 88 is splined to a support portion integrated flywheel fitting portion 106 having a spline tooth, which is provided on the inner peripheral surface of the support portion integrated flywheel 82, at the outer peripheral portion thereof. With such a structure, the first pressing plate 88 is provided so as not to be rotatable with respect to the support portion integrated flywheel 82 and so as to be movable in the direction of the axis C. A ring-shaped first pressing plate protruding portion 88a for receiving the pressure load P from the first diaphragm spring 90 is provided on the first pressing plate 88. In addition, the support portion integrated flywheel 82 is integrally fixed to a crank shaft 110 of the engine with a bolt 108.

Similarly, a second clutch disc 92 is integrally fixed to a second clutch disc hub 112 with a rivet 114 at an inner periphery portion thereof. The second clutch disc 92 is provided so as not to be rotatable with respect to the second input shaft 76 and so as to be movable in the direction of the axis C, when the second clutch disc hub 112 is splined to a second input shaft fitting portion 116 having a spline tooth, which is formed at a shaft end of the second input shaft 76. The friction member 94 is provided integrally on each of both the outer peripheral surfaces of the second clutch disc 92 at a position at which the friction member 94 contacts the pressed plate 86 or the second pressing plate 96, that is, at substantially the same position as the pressed plate 86 and the pressing plate 96 in the radial direction. The second pressing plate 96 is splined to a support portion integrated flywheel fitting portion 118 having a spline tooth, which is formed on the inner peripheral surface of the support portion integrated flywheel 82 at the outer peripheral portion thereof. With such a structure, the second pressing plate 96 is provided so as not to be rotatable with respect to the support portion integrated flywheel 82 and so as to be movable in the direction of the axis C. A ring-shaped second pressing plate protruding portion 96a for receiving the pressure load P from the second diaphragm spring 98 is provided on the second pressing plate 96.

Each of the first diaphragm spring 90 and the second diaphragm spring 98 has the partial cone shape with the predetermined apex angle r, as in the case of the diaphragm spring 24 in the embodiment shown in FIGS. 1 and 3, as shown in FIG. 2. The first diaphragm spring 90 has a ring-shaped portion 90a and a protruding portion 90b. The second diaphragm spring 98 has a ring-shaped portion 98a and a protruding portion 98b. Each of the first diaphragm spring 90 and the second diaphragm spring 98 in the embodiment has the same T/O characteristic as the diaphragm spring 24 in the first embodiment. The first diaphragm spring 90 is provided such that the protruding portion 90b is fitted to a support portion 128 having supporting members 124 and 125, which is formed integrally with the support portion integrated flywheel 82, through a hole portion 120 formed in support portion integrated flywheel 82. Similarly, the second diaphragm spring 98 is provided such that the protruding portion 98b is fitted to a support portion 130 having supporting members 126 and 127, which is formed integrally with the support portion integrated flywheel 82, through a hole portion 122 formed in support portion integrated flywheel 82. In the state of the first clutch 70 shown in FIG. 6, the pressure load P is applied to the first pressing plate 88 in the rightward direction in FIG. 6, that is, the pressing direction A, by the first diaphragm spring 90 using the supporting members 124 and 125 as the supporting points. At this time, the first clutch disc 78 is in the engaged state, that is, the first clutch disc 78 is pressed to the pressed plate 86 and the first pressing plate 88. Namely, the power from the engine is transmitted to the stepped automatic transmission 77 via the first clutch 70. On the other hand, in the state of the second clutch 72 shown in FIG. 6, the pressure load P is not applied to the second pressing plate 96 by the second diaphragm spring 98 using the supporting members 126 and 127 as the supporting points. At this time, the second clutch disc 92 is in the disengaged state, that is, the second clutch disc 92 is not pressed to the pressed plate 86 and the second pressing plate 96. Namely, the power transmission from the engine to the stepped automatic transmission 77 is interrupted by the second clutch 72. As mentioned above, the spring force, the shape, the position and the like of the first diaphragm spring 90 and the second diaphragm spring 98 are appropriately set such that the first clutch 70 is brought to the engaged state or the second clutch 72 is brought to the disengaged state using the force for attempting to maintain the partial cone shape of the first diaphragm spring 90 and the second diaphragm spring 98.

Next, a description will be made concerning the case where the first clutch 70 shown in FIG. 6 is changed from the engaged state to the disengaged state, and the case where the second clutch 72 shown in FIG. 6 is changed from the disengaged state to the engaged state.

As shown in FIG. 6, the friction engaging device according to the embodiment includes an actuator for elastically deforming the first diaphragm spring 90 and the second diaphragm spring 98, for example, the hydraulic cylinder 40 which is the same as that in the embodiment shown in FIGS. 1 and 3. The first diaphragm spring 90 and the second diaphragm spring 98 are elastically deformed as shown by dashed lines via a diaphragm spring operation member 132. After the first diaphragm spring 90 and the second diaphragm spring 98 are elastically deformed, the pressure load P applied to the first pressing plate 88 by the first diaphragm spring 90 is cancelled, and the first clutch 70 is disengaged. Meanwhile, the pressure load P due to the second diaphragm spring 98 is applied to the second pressing plate 96 in the leftward direction in FIG. 6, that is, the pressing direction B, and the second clutch 72 is engaged.

For example, the diaphragm spring operation member 132 includes a ring-shaped first member 132a and a ring-shaped second member 132b which are integrally fixed to each other with a rivet 134, and a first engagement portion 132c and a second engagement portion 132d which are formed by the first member 132a and the second member 132b. The ring-shaped portion 90a of the first diaphragm spring 90 is held by the first engagement portion 132c. Also, the ring-shaped portion 98a of the second diaphragm spring 98 is held by the second engagement portion 132d. The diaphragm spring operation member 132 is coupled to the piston 46 so as to be rotatable with respect to the piston 46 and so as to be immovable with respect to the piston 46 in the direction of the axis C, at a coupling portion 140 via a bearing 136 and a bearing coupling member 138. With this structure, when the hydraulic pressure in the second oil chamber 54 is made higher than the hydraulic pressure in the first oil chamber 50, the piston 46 moves in the rightward direction in FIG. 6. Thus, the ring-shaped portion 90a held by the first engagement portion 132c and the ring-shaped portion 98a held by the second engagement portion 132d are pulled in the rightward direction in FIG. 6. As a result, the first diaphragm spring 90 and the second diaphragm spring 98 are elastically deformed and reversed. After the first diaphragm spring 90 and the second diaphragm spring 98 are elastically deformed, as shown by dashed lines in FIG. 6, the pressure load P applied to the first pressing plate 88 by the first diaphragm spring 90 is cancelled, and the first clutch 70 is disengaged. Meanwhile, the pressure load P is applied to the second pressing plate 96 by the second diaphragm spring 98, and the second clutch 72 is engaged. An angular ball bearing is used as the bearing 136 in the embodiment. However, the bearing 136 is not limited to the angular ball bearing. The bearing 136 may be any types of bearings as long as the bearing can be formed such that the diaphragm spring operation member 132 and the bearing coupling member 138 are immovable with respect to each other in the direction of the axis C. For example, bearings such as a tapered roller bearing may be used.

At this time, the pressure load P due to the first diaphragm spring 90 is applied to a non-pressing direction A′, which is the direction opposite to the pressing direction A, due to the T/O characteristic of the first diaphragm spring 90. Also, the pressure load P due to the second diaphragm spring 98 is applied in the pressing direction B due to the T/O characteristic of the second diaphragm spring 98. In this state, the disengaged state of the first clutch 70 and the engaged state of the second clutch 72 are maintained, even when pulling of the ring-shaped portion 90a and the ring-shaped portion 98a due to the operation of the hydraulic cylinder 40 in the rightward direction in FIG. 6 is not performed.

Therefore, the first diaphragm spring 90 is formed so as to be elastically deformable between the first shape shown by the solid line in FIG. 6, and the second shape shown by the dashed line in FIG. 6. In this case, the first shape is used for maintaining the state in which the pressure load P is applied to the first pressing plate 88 such that the engaged state of the first clutch 70 is maintained without operating the hydraulic cylinder 40. Also, the second shape is used for maintaining the state in which the pressure load P is not applied to the first pressing plate 88 such that the disengaged state of the first clutch 70 is maintained without operating the hydraulic cylinder 40.

Also, the second diaphragm spring 98 is formed so as to be elastically deformable between the first shape shown by the dashed line in FIG. 6, and the second shape shown by the solid line in FIG. 6. In this case, the first shape is used for maintaining the state where the pressure load P is applied to the second pressing plate 96 such that the engaged state of the second clutch 72 is maintained without operating the hydraulic cylinder 40. Also, the second shape is used for maintaining the state where the pressure load P is not applied to the second pressing plate 96 such that the disengaged state of the second clutch 72 is maintained without operating the hydraulic cylinder 40.

Next, a description will be made concerning the case where the first clutch 70 is changed from the disengaged state to the engaged state, and the case where the second clutch 72 is changed from the engaged state to the disengaged state. First, the hydraulic pressure in the first oil chamber 50 is made higher than the hydraulic pressure in the second oil chamber 54 due to the operation of the hydraulic cylinder 40, and the piston 46 is moved in the leftward direction in FIG. 6. Thus, the ring-shaped portion 90a held by the first engagement portion 132c and the ring-shaped portion 98a held by the second engagement portion 132d are pulled in the leftward direction in FIG. 6. As a result, the first diaphragm spring 90 is elastically deformed from the second shape to the first shape. At the same time, the diaphragm spring 98 is elastically deformed from the first shape to the second shape.

Next, a description will be made concerning the case where the first clutch 70 is changed from the engaged state to the disengaged state, and the case where the second clutch 72 is changed from the disengaged state to the engaged state. First, the hydraulic pressure in the second oil chamber 54 is made higher than the hydraulic pressure in the first oil chamber 50 due to the operation of the hydraulic cylinder 40, and the piston 46 is moved in the rightward direction in FIG. 6. Thus, the ring-shaped portion 90a held by the first engagement portion 132c and the ring-shaped portion 98a held by the second engagement portion 132d are pulled in the rightward direction in FIG. 6. As a result, the first diaphragm spring 90 is elastically deformed from the first shape to the second shape. Also, the second diaphragm spring 98 is elastically deformed from the second shape to the first shape.

As a result, the operation of the hydraulic cylinder 40 is required only when the first diaphragm spring 90 and the second diaphragm spring 98 are elastically deformed from the first shape to the second shape or from the second shape to the first shape. Meanwhile, in the steady state in which each of the first diaphragm spring 90 and the second diaphragm spring 98 is maintained in the first shape or the second shape, the operation of the hydraulic cylinder 40 is not required. Thus, an energy loss due to the continuous operation of the hydraulic cylinder is not caused, and therefore the fuel efficiency is increased. Also, the twin clutch 68 can be engaged/disengaged by using the hydraulic cylinder 40 as one actuator. Therefore, according to the embodiment, advantage is provided in the cost, the space required for mounting the friction engaging device in the vehicle, arrangement, and the like, compared to the case where actuators are provided for both the first clutch 70 and the second clutch 72. Accordingly, the fuel efficiency is increased. As in the case of the first embodiment, the above-mentioned hydraulic pressure is supplied using, as the original pressure the hydraulic pressure, which is generated by the mechanical oil pump operated by the engine or the electric oil pump that is driven by electric power from the battery, or the like. Accordingly, an energy loss may be caused due to the continuous operation of the hydraulic cylinder 40, and the fuel efficiency may be reduced.

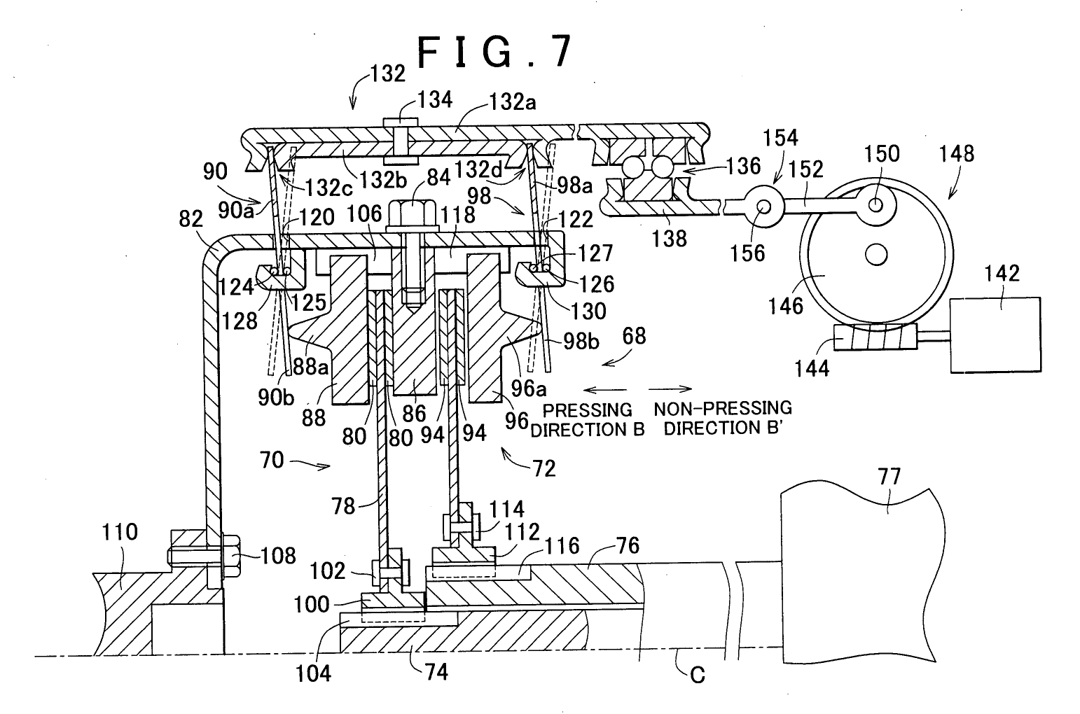

FIG. 7 shows a third embodiment. In the third embodiment,. as an actuator for elastically deforming the first diaphragm spring 90 and the second diaphragm spring 98, instead of the hydraulic cylinder 40 in the second embodiment, an electric motor 142 is provided. As in the case of the second embodiment, the first diaphragm spring 90 and the second diaphragm spring 98 are elastically deformed so as to be in the shape shown by the solid line or the dashed line via the diaphragm spring operation member 132. Due to this elastic deformation, the first clutch 70 is engaged and the second clutch 72 is disengaged. Alternatively, the first clutch 70 is disengaged and the second clutch 72 is engaged. Note that the structure, and the operations of the twin clutch 68 and the like in the third embodiment are the same as those in the embodiment shown in FIG. 6, except for the structure for coupling the electric motor 142 to the diaphragm spring operation member 132. Therefore, the description concerning the same elements as those in the embodiment shown in FIG. 6 is not made here.

For example, the electric motor 142 is operatively coupled to the diaphragm spring operation member 132 via a worm gear pair 148 including a worm 144 and a worm wheel 146; a coupling member 152 which is coupled to the worm wheel 146 with a pin 150; the bearing coupling member 138 which is coupled to a coupling member 152 with a pin 156 at a coupling portion 154 so as not to be rotatable with respect to the coupling member 152 at least in the direction of the axis C; and the bearing 136. With this structure, the rotation of the electric motor 142 is converted into the movement in the direction of the axis C. When the first clutch 70 is engaged and the second clutch 72 is disengaged, the electric motor 142 is rotated such that the first ring-shaped portion 90a held by the first engagement portion 132c and the ring-shaped portion 98a held by the second engagement portion 132d are pulled in the leftward direction in FIG. 7, and the first diaphragm spring 90 is elastically deformed from the second shape to the first shape, and the second diaphragm spring 98 is elastically deformed from the first shape to the second shape. Meanwhile, when the first clutch 70 is disengaged and the second clutch 72 is engaged, the electric motor 142 is rotated such that the ring-shaped portion 90a held by the first engagement portion 132c and the ring-shaped portion 98a held by the second engagement portion 132d are pulled in the rightward direction in FIG. 7, and the diaphragm spring 90 is elastically deformed from the first shape to the second shape and the second diaphragm spring 98 is elastically deformed from the second shape to the first shape.

As mentioned above, in the third embodiment, as in the case of the second embodiment, the operation of the electric motor 142 is required only when each of the first diaphragm spring 90 and the second diaphragm spring 98 is elastically deformed from the first shape to the second shape or from the second shape to the first shape. In the steady state, the continuous operation of the electric motor 142 which is driven by the electric power from the battery or the like is not required. Accordingly, an energy loss is not caused, and therefore the fuel efficiency is increased. Also, the twin clutch 68 can be engaged/disengaged by the electric motor 142 as one actuator. Therefore, according to the embodiment, advantage is provided in the cost, the space required for mounting the friction engaging device in the vehicle, arrangement, and the like, compared to the case where actuators are provided for both the first clutch 70 and the second clutch 72. Accordingly, the fuel efficiency is increased.

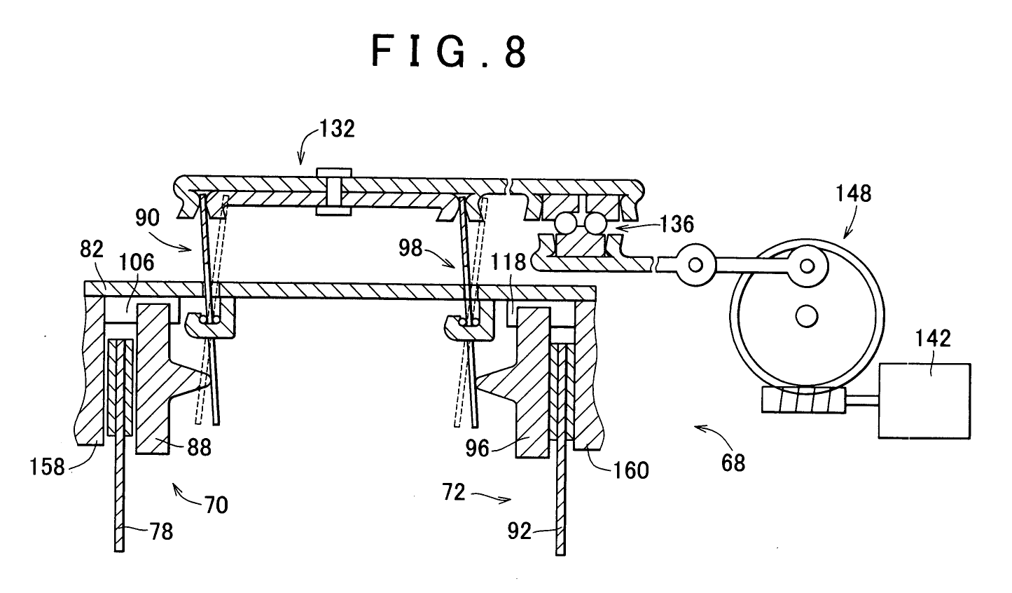

FIG. 8 shows a fourth embodiment. The positions and the structures of the first clutch 70 and the second clutch 72 in the fourth embodiment are different from those in the third embodiment. More particularly, in the third embodiment, the pressed plate 86 serves as one member of the paired members provided so as to be rotatable with respect to each other, which are provided to the first clutch disc 78 constituting the first clutch 70, and also serves as one member of the paired members provided so as to be rotatable with respect to each other, which are provided to the second clutch disc 92 constituting the second clutch 72. Instead of the pressed plate 86, a first pressed plate 158 is provided to the first clutch disc 78, and a second pressed plate 160 is provided to the second clutch disc 92 in the fourth embodiment. Also, in the fourth embodiment, the first clutch 70 and the second clutch 72 are provided such that the right-hand side and the left-hand side thereof are reversed, as compared to the third embodiment.

As in the case of the first pressing plate 88, the first pressed plate 158 has a ring shape. Also, the first pressed plate 158 is provided so as not to be rotatable with respect to the support portion integrated flywheel 82 and so as to be movable in the direction of the axis C, when the first pressed plate 158 is splined to the support portion integrated flywheel fitting portion 106 having a spline tooth, which is formed on the inner peripheral surface of the support portion integrated flywheel 82, at the outer periphery portion. The first pressed plate 158 is immovably fixed to the support portion integrated flywheel fitting portion 106 with a ring-shaped snap ring, which is fitted to the support portion integrated flywheel fitting portion 106, so as to press the first clutch disc 78. As in the case of the second pressing plate 96, the second pressed plate 160 has a ring shape. Also, the second pressed plate 160 is provided so as not to be rotatable with respect to the support portion integrated flywheel 82 and so as to be movable in the direction of the axis C, when the second pressed plate 160 is splined to the support portion integrated flywheel fitting portion 118 having a spline tooth, which is formed on the inner peripheral surface of the support portion integrated flywheel 82, at the outer periphery portion. The second pressed plate 160 is immovably fixed to the support portion integrated flywheel fitting portion 118 with a ring-shaped snap ring, which is fitted to the support portion integrated flywheel fitting portion 118, so as to press the second clutch disc 92.

As mentioned above, the structure in fourth embodiment is the same as that in the first embodiment except for the fact that the operation of the twin clutch 68 is in the opposite direction in the direction of the axis C and the positions and the structures of the first clutch 70 and the second clutch 72 are different between the third embodiment and the fourth embodiment. Therefore, the description concerning the same elements will not made here, since the same effects can be obtained also in the fourth embodiment. The fourth embodiment is an example of the position and the structure of the twin clutch 68, which are different from those in the third embodiment, and various other embodiments can be realized. For example, the operation point at which the first diaphragm spring 90 or the second diaphragm spring 98 is elastically deformed from the first shape to the second shape or from the second shape to the first shape may be different between the first diaphragm spring 90 and the second diaphragm spring 98. Thus, with only one actuator, the first diaphragm spring 90 and the second diaphragm spring 98 can be engaged or disengaged simultaneously, or can be engaged or disengaged independently.

So far, the embodiments according to the invention have been described in detail with reference to accompanying drawings. However, the invention can be realized in the other embodiments.

For example, in the above-mentioned embodiments, the friction engaging device is the brake 12 constituting the stepped automatic transmission 10 for a vehicle or the twin clutch 68 for transmitting/interrupting the power from the engine to the stepped automatic transmission 77 including the two input shaft. However, the friction engaging device is not limited to these. The invention can be applied to a clutch constituting the stepped automatic transmission 10, an automatic clutch of a dry single plate diaphragm spring type which is combined with a manual transmission, an input clutch which transmits/interrupts the power from the engine to a continuously variable transmission whose shift speed is continuously changed, or a forward/backward running changing device which is combined with a continuously variable transmission. Namely, the invention can be applied to any types of friction engaging device, as long as the friction engaging device is used for stopping rotation, or used for transmitting/interrupting or changing the power from the engine in a power transmission route for transmitting the power from the engine to a drive wheel. For example, when the invention is applied to a clutch or a brake constituting the stepped automatic transmission 10, the operation of the hydraulic cylinder 40 for achieving a shift speed of the stepped automatic transmission 10 is not required when shifting of the stepped automatic transmission 10 is not performed. As a result, an energy loss due to the continuous operation of the hydraulic cylinder 40 is not caused, and the fuel efficiency is increased. Also, as the drive power source for running, an electric motor or the like may be used instead of the engine. Also, the invention can be applied to a friction engaging device which is used for an element other than a vehicle.

Also, in the above-mentioned embodiments, each of the diaphragm spring 24, the first diaphragm spring 90 and the second diaphragm spring 98 has the ring-shaped portion 24a which is a ring-shaped spring member; and the protruding portion 24b. However, the invention can be applied to a so-called disc spring which does not have the protruding portion 24b.

Also, in the above-mentioned embodiments, each of the brake 12 and the twin clutch 68 is a single plate type friction engaging device in which the number of friction plates of the brake disc 14, the first clutch disc 78 or the second clutch disc 92 is one. However, the invention is not limited to this. A multi-plate type friction engaging device having plural friction plates may be used. In this case, the pressing plates corresponding to the pressing plate 22 without the protruding portions and the plural friction plates are alternatively provided in the direction of the axis C. Also, various embodiments can be realized concerning the coupling form between the intermediate shaft 26 and the first input shaft 74 and the like, and the snap ring 36 for positioning and the like. For example, the housing fitting portion 34 may be formed so as to have a function as a member for positioning the pressed plate 20.

Also, the hydraulic cylinder 40 in the above-mentioned embodiments mainly includes the ring-shaped cylinder housing 44 and the piston 46. In this case, the bearing 136 need not be provided.

Also, in the above-mentioned embodiments, as the actuator, the hydraulic cylinder 40 or the electric motor 142 is used. However, bi-directional actuators such as various types of motors, cylinders and the like, for example, hydraulic, electromagnetic, or pneumatic motors and cylinders may be used.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A friction engaging device, comprising:
a friction member which is attached to one member of paired members that are coaxially provided so as to be rotatable with respect to each other;
a pressing member which presses the friction member to the other member of the paired members; and
a spring which makes the pressing member generate a pressure load for pressing the friction member to the other member of the paired members; and
an actuator which elastically deforms the spring, wherein the spring is formed so as to be elastically deformable between a first shape for maintaining a state in which the pressing member is made to generate the pressure load and a second shape for maintaining a state in which the pressing member is not made to generate the pressure load, the spring is elastically deformed from the second shape to the first shape due to operation of the actuator in order to engage the paired members with each other, and the spring is elastically deformed from the first shape to the second shape due to the operation of the actuator in order to disengage the paired members from each other.

2. The friction engaging device according to claim 1, wherein
the friction engaging device is at least one of a clutch and a brake whose engagement operation is controlled in order to achieve a shift speed of a stepped automatic transmission for a vehicle.

3. The friction engaging device according to claim 1, wherein
the friction engaging device is a clutch for a vehicle, which is provided between an engine and a drive shaft in the vehicle and which is used for transmitting/interrupting power from the engine.

4. The friction engaging device according to claim 1, wherein
the spring is a diaphragm spring having a cone-shaped portion in which an inner periphery is deviated with respect to an outer periphery in an axial direction.

5. The friction engaging device according to claim 4, wherein
the friction engaging device is at least one of a clutch and a brake whose engagement operation is controlled in order to achieve a shift speed of a stepped automatic transmission for a vehicle.

6. The friction engaging device according to claim 4, wherein
the friction engaging device is a clutch for a vehicle, which is provided between an engine and a drive shaft in the vehicle and which is used for transmitting/interrupting power from the engine.
